(19) United States
(12) Patent Application Publication
(10) Pub. No.: US 2005/0016871 A1
(43) Pub. Date: Jan. 27, 2005

(54) Determining gas concentration

(76) Inventors: Richard Guy Compton, Oxford (GB); Clive Edward Winston Hahn, Oxford (GB); Jay Deep Wadhawan, Oxford (GB); Peter James Welford, Derby (GB)

Correspondence Address: QUARLES & BRADY LLP, 411 E. WISCONSIN AVENUE, SUITE 2040, MILWAUKEE, WI, 53202-4497, US

(21) Appl. No.: 10/491,479

(22) PCT Filed: Sep. 30, 2002
(86) PCT No.: PCT/GB02/04401

(30) Foreign Application Priority Data
Oct. 1, 2001 (GB) 0123552.2
Jan. 29, 2002 (GB) 0202019.6

(51) Int. Cl. G01N 27/403

(52) U.S. Cl. 205/782

(57) ABSTRACT

A method of determining the concentration of oxygen gas, [O₂] and the concentration of carbon dioxide gas, [CO₂], in a fluid, which method comprises: (a) applying the fluid to one side of a membrane permeable to the gases, the other side of the membrane retaining a solvent for the gases, (b) using a working micrelectrode in contact with the solvent to apply a first electric potential which is effective to reduce oxygen in the solvent and a second electric potential which is effective to reduce carbon dioxide in the solvent, (c) measuring a first steady-state limiting electric current, i₁ corresponding to the reduction of O₂ to O_{2.}⁻ and a second steady-state limiting electric current, i₂ corresponding to both further reduction of O₂ and reduction of CO₂, and (d) de-convoluting i₁ and i₂ to determine [O₂] and [CO₂].

The present invention relates to a method and apparatus for determining the concentrations of oxygen and carbon dioxide gases in a fluid. The fluid may be in the liquid or gas phase and may be, for example, a body fluid such as whole blood or serum.

The continuous measurement of oxygen and carbon dioxide in clinical medicine has led to a whole industry of measurement devices. In the blood, oxygen is measured by the amperometric Clark PO₂ electrode, and carbon dioxide is measured by the potentiometric (glass electrode) Stow-Severinghaus electrode. Thus two sensors, working on entirely different principles, have to be employed whenever the concentrations of both oxygen and carbon dioxide are measured. Blood gas analysers therefore use two separate sensors. Intravascular measurements can only be made for oxygen, using Clark cells fabricated on the tip of a polymer catheter. It has proved impossible, so far, to miniaturise the glass electrode, and so measure intravascular carbon dioxide concentration, with the Stow-Severinghaus technique. Paediatric intravascular oxygen sensors have been successfully developed, first by D. G. Searle and then by Hoffman la Roche, for paediatric use, and these sensors are now manufactured by Biomedical Sensors Ltd. (High Wycombe).

In the gaseous phase, oxygen is measured with Clark-type sensors for steady-state analysis (e.g. for anaesthetic machines), and by fast paramagnetic analysers for breath-by-breath analysis. Expired carbon dioxide is almost inevitably measured with an infrared analyser.

Outside medicine, as the control of carbon dioxide increases in various technologies, there is an ever growing need for inexpensive carbon dioxide sensors with high sensitivity and selectivity. Such examples include the fermentation industry in general, brewing, on-line industrial monitoring, pollution measurement, carbon dioxide level measurement in large auditoria, vehicle exhaust analysis, etc. In many instances it would be a great advantage to be able to measure oxygen concentration simultaneously, with the same sensor measuring both oxygen and carbon dioxide concentrations.

At potentials of the order of −0.5 to −1.0 V and more negative against a pseudo-Ag reference electrode, in an aprotic solvent such as dimethylsulfoxide (DMSO), oxygen in solution is reduced by the reaction:
O₂+e→O₂.⁻ (I)

The resulting superoxide radical is stable for short periods in non-aqueous solvents. But it reacts rapidly with carbon dioxide, by a series of reactions which may be summarised as:
2O₂.⁻+2CO₂→C₂O₆²⁻+O₂ (II)

At potentials in the range −1.5 to −2.5 V or more negative, dissolved carbon dioxide is reduced, initially by virtue of the reaction:
CO₂+e→CO₂.⁻ (III)

EP-A-0162622 describes a gas sensor and method which use reactions (I) and (II) to provide a simultaneous determination of oxygen and carbon dioxide concentrations. A pulsed CO₂ titration technique is described in which the electrode surface is kept deliberately large in order to produce enough O₂.⁻ to consume all the CO₂ present. A pulsed voltage sufficiently negative to reduce the O₂ molecule (but not sufficiently negative to reduce CO₂) is first applied to the electrode surface, followed by an oxidising pulse to oxidise those O₂.⁻ ions which have remained after the reaction with CO₂. However, the method described in EP-A-0162622 has certain disadvantages. For example, a large cathode surface is needed, leading to high sample consumption, a complicated mathematical relationship is required to extract the CO₂ concentration, and the measured O₂ concentration is complicated by the enhancement of its signals from the chemical reactions (I) and (II) shown above.

WO 95/00838 describes a device and method which use reactions (I) and (III) above under conditions such that the interference from reaction (II) is minimised, for example by controlling the rate of potential sweep of the working electrode. However, using the method described in WO 95/00838, it has proved difficult to reduce the interference from reaction (II) to an acceptable level when the concentration of carbon dioxide is low, for example less than about 3 vol %.

The present inventors have now found that it is possible to de-convolute the steady-state limiting electric currents associated with the oxygen and carbon dioxide waves at a microelectrode to determine a unique pair of concentration values that will give rise to the measured signals, without taking steps to minimise the effect of reaction (II) above. This approach readily allows the determination of both oxygen and carbon dioxide concentrations, even when the concentration of carbon dioxide is less than about 3 vol %.

The present invention accordingly provides a method of determining the concentration of oxygen gas, [O₂], and the concentration of carbon dioxide gas, [CO₂], in a fluid, which method comprises:
(a) applying the fluid to one side of a membrane permeable to the gases, the other side of the membrane retaining a solvent for the gases,
(b) using a working microelectrode in contact with the solvent to apply a first electric potential which is effective to reduce oxygen in the solvent and a second electric potential which is effective to reduce carbon dioxide in the solvent,
(c) measuring a first steady-state limiting electric current, i₁, corresponding to the reduction of O₂ to O₂.⁻ and a second steady-state limiting electric current, i₂, corresponding to both further reduction of O₂ and reduction of CO₂, and
(d) de-convoluting i₁ and i₂ to determine [O₂] and [CO₂].

In one embodiment of the invention, step (d) comprises determining [O₂] and [CO₂] from a look-up table which provides a one-to-one correspondence between pairs of values of i₁ and i₂ and pairs of values of [O₂] and [CO₂].

In a further embodiment of the invention, step (d) comprises calculating [O₂] and [CO₂] in an iterative process.

The iterative process may comprise calculating initial values of [O₂] and [CO₂] based on an assumed value of the effective number of electrons N_{eff} transferred during the oxygen reduction process, using these values of [O₂] and [CO₂] to calculate an improved value of N_{eff}, using the improved value of N_{eff} to calculate improved values of [O₂] and [CO₂], and repeating the calculation of improved values of N_{eff}, [O₂] and [CO₂] until successive values obtained for [O₂] and [CO₂] converge to within a desired tolerance.

More specifically, the iterative process may comprise:
(d1) assuming that the effective number of electrons N_{eff} transferred during the oxygen reduction process is equal to 2, and calculating a lower bound for [O₂] and an upper bound for [CO2] using the equations
   i₁=χN_{eff}[O₂] (1)
   i₂=2χ[O₂]+κ[CO₂] (2)
   in which χ and κ are empirically determined calibration constants,
(d2) identifying by reference to empirical data the effective number of electrons N_{eff} which would be transferred if the oxygen reduction process took place at an oxygen concentration [O₂] and a carbon dioxide concentration [CO₂] as calculated in step (d1),
(d3) using the value of N_{eff} obtained in step (d2) to calculate an improved value of [O₂] using equation (1),
(d4) using the value of [O₂] obtained in step (d3) to calculate an improved value of [CO₂] using equation (2), and
(d5) repeating steps (d2) to (d4), but using in step (d2) the values of [O₂] and [CO₂] last obtained in steps (d3) and (d4), until successive values obtained for [O₂] and [CO₂] converge to within a desired tolerance.

In a further embodiment of the invention, step (d) comprises calculating [O₂] and [CO₂] using the approximate equations
i₁=χ[O₂](1+[CO₂]/2.5) (7)
i₂=2i₁/(1+[CO₂]/2.5)+κ[CO₂] (8)
in which χ and κ are as defined above, and [O₂] and [CO₂] are expressed in units of mmol dm⁻³.

The present invention also provides an apparatus for determining the concentrations of oxygen and carbon dioxide gases in a fluid, which comprises a membrane permeable to the gases, a solvent for the gases which is retained by the membrane, a working microelectrode and a counter and/or reference electrode in contact with the solvent, means for applying to the working microelectrode a first electric potential which is effective to reduce oxygen in the solvent and a second electric potential which is effective to reduce carbon dioxide in the solvent, and means for measuring a first steady-state limiting electric current, i₁, corresponding to the reduction of O₂ to O₂.⁻ and a second steady-state limiting electric current, i₂, corresponding to both further reduction of O₂ and reduction of CO₂, the apparatus being configured to carry out step (d) as defined above.

The present invention will be further described with reference to the accompanying drawings in which:

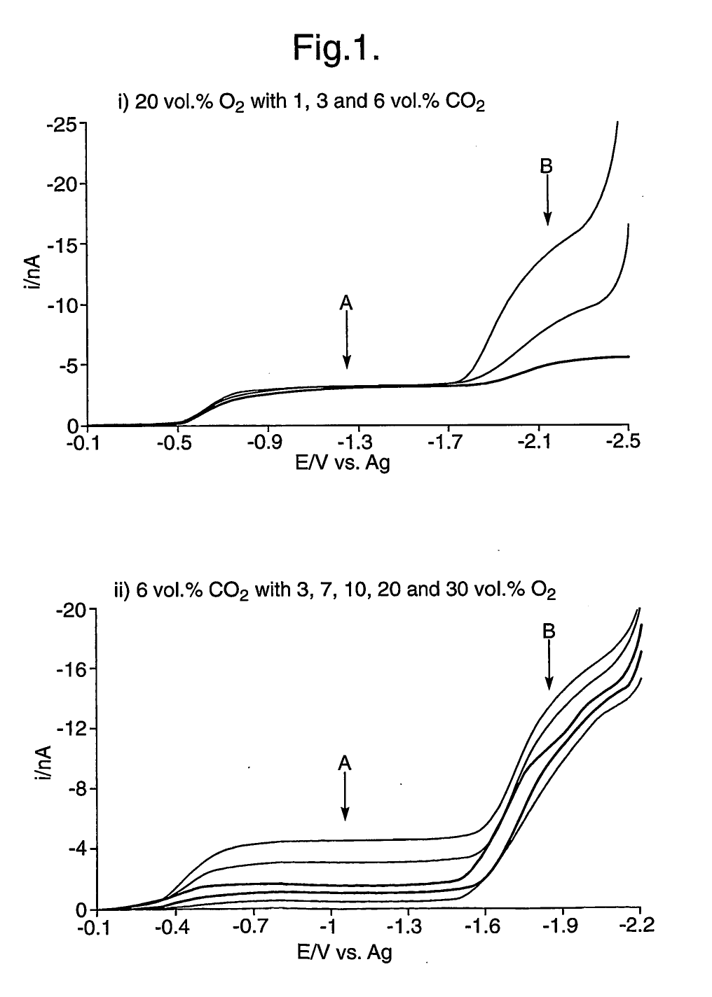

FIGS. 1(i) and (ii) illustrate voltammograms obtained at a range of different oxygen and carbon dioxide concentrations;

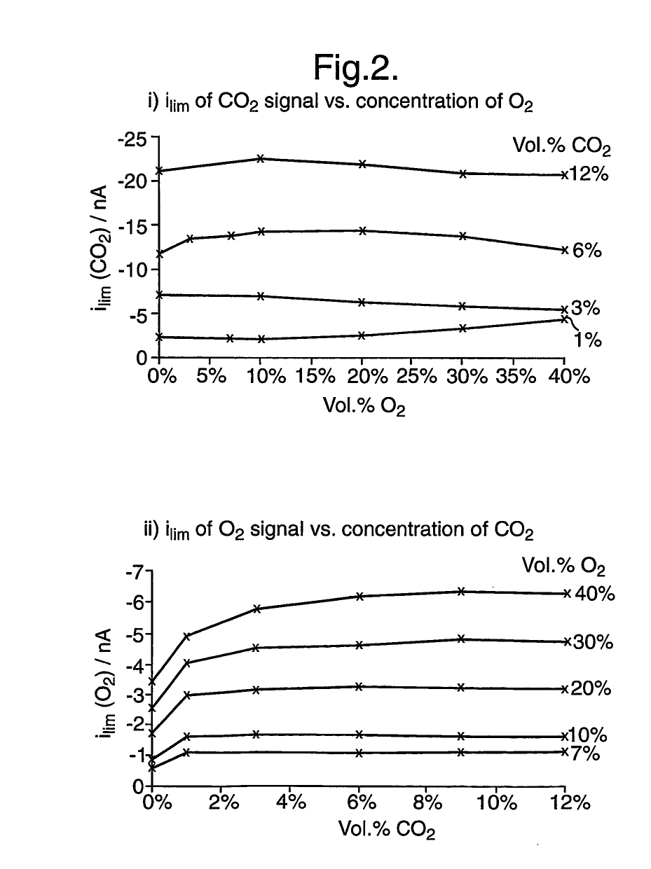

FIGS. 2(i) and (ii) illustrate steady-state limiting electric currents for each gas plotted as a function of the concentration of the other gas;

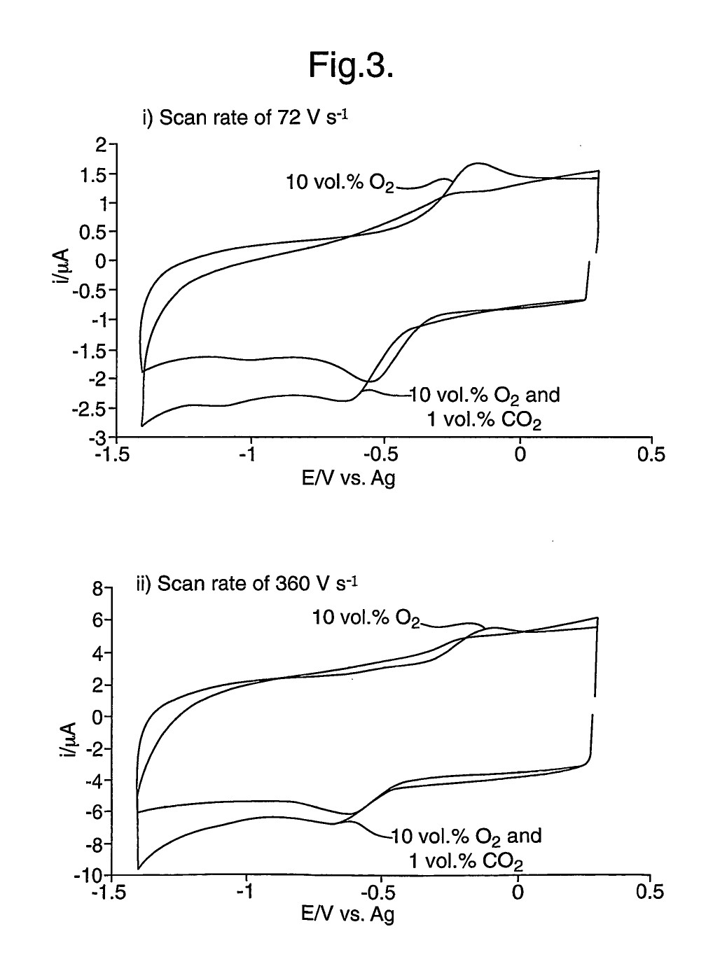

FIGS. 3(i) and (ii) illustrate fast scan cyclic voltammograms for oxygen reduction obtained both in the presence and absence of carbon dioxide;

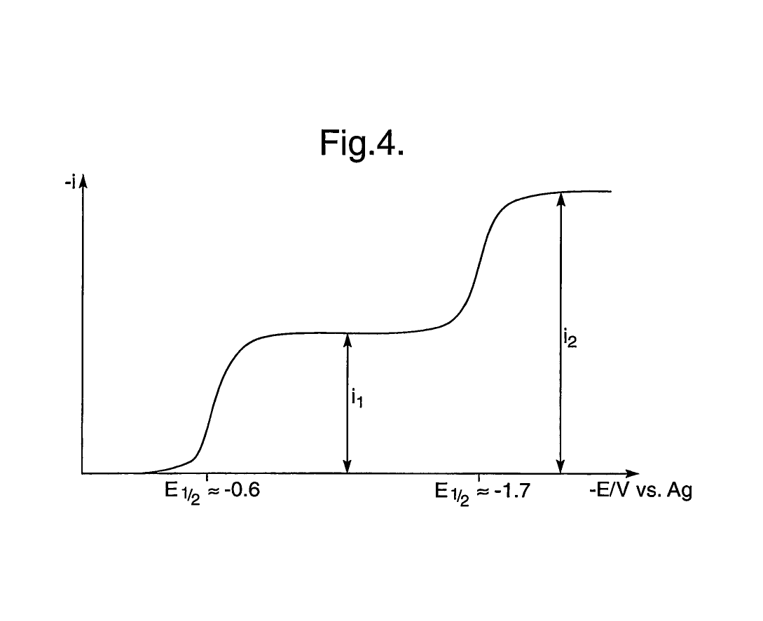

FIG. 4 schematically illustrates a typical voltammogram obtained at a microelectrode in the presence of both oxygen and carbon dioxide; and

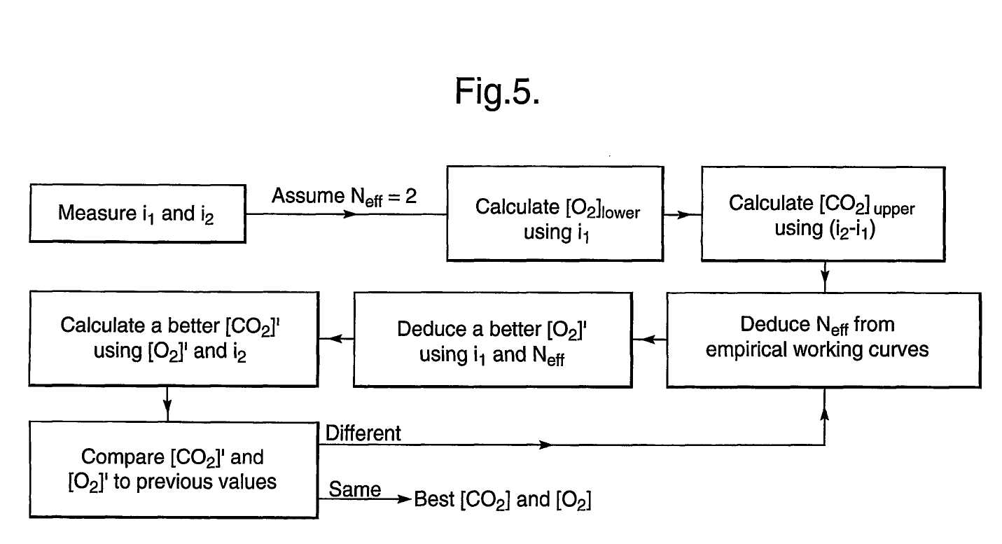

FIG. 5 is a flow chart illustrating an iterative method for determining [O₂] and [CO₂].

The data for the fast scan experiments were recorded using a THANDAR TG1304 function generator and a Tektronix TDS 3032 oscilloscope (300 MHz bandpass, 2.5 GS/s); steady-state currents were recorded using a PGSTAT30 Autolab (Eco-Chemie, Utrecht).

FIGS. 1(i) and (ii) illustrate linear-sweep voltammograms (50 m Vs⁻¹) for the reduction of O₂ and CO₂ in the presence of each other at a 9.8 μm diameter gold microdisc working electrode in 0.2 M TEAP/DMSO (where TEAP signifies tetraethylammonium perchlorate). The small-volume electrochemical cell (ca. 10 cm³) was shielded from direct sunlight, to minimise light-accelerated DMSO disproportionation. The working electrode comprised gold wires sealed in borosilicate glass, the ends of which were polished to flatten the microdisc surface. The electric currents in FIGS. 1(i) and (ii) are steady-state currents. Only two signals or waves are observed. The first signal (marked “A”) corresponds to the reduction of O₂ to O_{2.}⁻, while the second (marked “B”) is two essentially superimposed signals due to both further reduction of O₂ and CO₂ reduction.

In FIGS. 2(i) and (ii), the steady-state limiting electric currents for each gas have been plotted as a function of the concentration of the other gas. For CO₂ the limiting currents have been obtained by subtracting the height of the first wave from that of the second. It can be seen that the CO₂ signal is independent of the vol % O₂ but the O₂ signal appears to be independent of the vol % CO₂ only at CO₂ concentrations of greater than about 2 vol %. At CO₂ concentrations below this value, the current due to O₂ reduction is one half of that observed at high CO₂ concentrations. This is indicative of a switch in the mechanistic pathway from the consumption of one electron to the consumption of two electrons. At low CO₂ levels, at the lower potentials, O₂ is reduced in a one-electron process to O_{2.}⁻, whereas at higher CO₂ levels a “titration” occurs, in which O_{2.}⁻ reacts with CO₂ in an overall two-electron process:
O₂+2CO₂+2e→C₂O₆²⁻
The apparent independence of the CO₂ signal with O₂ arises as a consequence of the much greater solubility of CO₂ in 0.2 M TEAP/DMSO; ca. 60 times more soluble than O₂. Thus, at the larger CO₂ concentrations, titration of a comparatively small amount of CO₂ with O₂.⁻ makes little difference to the observed voltammetry.

FIGS. 3(i) and (ii) illustrate fast scan cyclic voltamrograms for O₂ reduction at a 125 μm diameter gold disc electrode to generate O_{2.}⁻ both in the presence and absence of CO₂. An ultrafast potentiostat was used with ohmic drop compensation and a current amplification of 0.9×10⁵. At a scan rate of 72 Vs⁻¹ in the absence of CO₂, two peaks are observed, with a half-wave potential E_{1/2}, calculated in terms of the peak potentials Eₚ^{red} and Eₚ^{ox} of E_{1/2}=½(Eₚ^{red}+Eₚ^{ox})=−0.36 V vs. Ag, corresponding to the reversible one-electron O₂ reduction. The difference in height between the forward and reverse peaks is likely to be due to the diffusion coefficient of O_{2.}⁻ in DMSO electrolyte solutions being ca. two times smaller than that of O₂. In the presence of CO₂, although the formation of O₂.⁻ is observed at this scan rate, only a very small reverse peak is detected. Furthermore, the O₂.⁻ formation wave is enhanced by the presence of CO₂. These results can be interpreted by a reaction of O_{2.}⁻ with CO₂ involving an additional electron transfer process. At a scan rate of 360 Vs⁻¹ the timescale of the experiment is shorter, resulting in a reduced reaction of O₂.⁻ with CO₂. In the presence of CO₂ a peak corresponding to O₂.⁻ oxidation is evident and the O₂ reduction signal is enhanced, indicating that the reaction still occurs. The kinetics of the nucleophilic addition reaction are just about “outrun” in the timescale of this experiment (less than 10⁻³ s).

A typical steady-state voltammetric response obtained at a mnicroelectrode in the presence of both O₂ and CO₂ is shown schematically in FIG. 4 of the accompanying drawings. Two waves are produced on a voltammogram, the first corresponding to the reduction of O₂ and the second corresponding to the reduction of CO₂. At carbon dioxide concentrations greater than 2 vol %, superoxide generated during the first wave reacts with CO₂ in an overall two-electron process. The mechanism for this reaction, involving heterogeneous transfer of an electron to O₂ at the electrode surface and nucleophilic addition of O₂.⁻ to CO₂, is believed to be:
2O₂+2e→2O_{2.}⁻
O₂.⁻+CO₂→CO₄.⁻
CO₄.⁻+CO₂→C₂O₆.⁻
C₂O₆.⁻+O₂.⁻→C₂O₆²⁻+O₂
In this range the O₂ signal, i₁, is effectively independent of the concentration of CO₂. Likewise, the CO₂ signal, (i₂−i₁), is independent of the concentration of O₂. However, at CO₂ concentrations less than 2 vol %, the two signals are not independent. At these lower CO₂ concentrations, to deduce the O₂ concentration from the first voltammetric wave requires a knowledge of the effective number of electrons N_{eff} transferred during the reaction process, which is itself dependent on the CO₂ concentration and has a value in the range from 1 to 2.

For a microdisc electrode, theory predicts that the first steady-state limiting current i₁ is given by the equation:
i₁=χN_{eff}[O₂] (1)
in which χ=4FrₑD_{O2}, F is the Faraday constant (96485 C mol⁻¹), rₑ is the electrode radius and D_{O2} is the diffusion coefficient of oxygen.

The second signal i₂ comprises the two-electron reduction of O₂ and the one-electron CO₂ reduction and may be written as:
i₂=2χ[O₂]+κ[CO₂] (2)
in which κ=4FrₑD_{CO2}, F and rₑ are as defined above and D_{CO2} is the diffusion coefficient of carbon dioxide.

In practice, χ and κ may be treated as calibration constants. They may be determined by measurement in air (effectively 20 vol % O₂ and negligible CO₂) together with the ratio of the diffusion coefficients (ca. 2.1) and the solubilities. Alternatively, χ and κ may be determined using equation (2), for example by measuring i₂ as a function of either [O₂] or [CO₂] while the concentration of the other gas is kept fixed. Once χ is known, the functional dependence of N_{eff} on [CO₂] can be determined using equation (1), for example by measuring i₁ as a function of [CO₂] while [O₂] is kept fixed. Likewise, the dependence of N_{eff} on [O₂] can be determined by measuring i₁ as a function of [O₂] while [CO₂] is kept fixed. The temperature of the calibration needs to match the temperature at which measurements are to be taken. In practice, it may be useful to obtain calibration data at a range of different temperatures.

The present inventors have found that, despite the interference from reaction (II) above, there is still a one-to-one correspondence between pairs of values of i₁ and i₂ and pairs of values of [O₂] and [CO₂]. It is therefore possible to deconvolute the experimentally determined values of i₁ and i₂ and thus uniquely determine the values of [O₂] and [CO₂], regardless of whether a high or low concentration of carbon dioxide is present. There are various different ways of deconvoluting i₁ and i₂. For example, [O₂] and [CO₂] may be determined from the experimentally determined values of i₁ and i₂ using a look-up table, or by using an iterative method, or approximate values for [O₂] and [CO₂] may be determined by assuming some approximate functional relationship between N_{eff} and [CO₂] and solving the resulting simultaneous equations.

An example of an iterative method for determining [O₂] and [CO₂] is illustrated by the flow chart shown in FIG. 5 of the accompanying drawings. It is first assumed that N_{eff} is equal to its maximum possible value of 2. Substituting this value into equations (1) and (2) gives
i₁=2χ[O₂]_{lower} (3)
i₂−i₁=κ[CO₂]ᵤₚₚₑᵣ (4)
where [O₂]_{lower} is a lower bound for the oxygen concentration and [CO₂]ᵤₚₚₑᵣ is an upper bound for the carbon dioxide concentration. An improved value for the effective number of electrons N_{eff} transferred during the oxygen reduction process is then deduced from the empirical data, using these two concentrations. A closer approximation to the oxygen concentration [O₂]′ is then calculated from equation (1) using the measured i₁ and the improved N_{eff}. A closer approximation to the carbon dioxide concentration [CO₂]′ is then inferred from equation (2) using the measured i₂ and the value calculated for [O₂]′. The procedure of determining N_{eff} and then deducing more accurate [O₂]′ and [CO₂]′ values is continued until successive approximations converge to within a desired tolerance.

Approximate values for the oxygen and carbon dioxide concentrations may also be determined from the experimental values of the limiting currents i₁ and i₂ by assuming that N_{eff} varies linearly with [CO₂] in the range 0-2 vol % (0-2.5 mM) CO₂, such that:
N_{eff}=1+[CO₂]/2.5, 0≦vol % CO₂<2 (5)
N_{eff}=2, vol % CO₂≧2 (6)
For high CO₂ concentrations, substituting equation (6) into equations (1) and (2) gives equations (3) and (4) above. Hence i₁ and (i₂−i₁) are proportional to the concentrations of O₂ and CO₂ respectively. In contrast, for low CO₂ concentrations, substituting equation (5) into equations (1) and (2) gives:
i₁=χ[O₂](1+[CO₂]/2.5) (7)
i₂=2i₁/(1+[CO₂]/2.5)+κ[CO₂] (8)
Clearly the two signals are not independent at low CO₂ concentrations. However, a unique combination of O₂ and CO₂ concentrations may be still be calculated for each pair of values of i₁ and i₂. From equation (8), the CO₂ concentration is:
[CO₂]=(−b±(b²−4ac)^{1/2})/2a (9)
where a=κ, b=5κ/2−i₂, and c=5 (2i₁−i₂)/2. The constant a must always be positive, b may be positive or negative depending on [O₂], and c must always be negative (or zero for 0 vol % CO₂). Hence the determinant (b²−4ac) is always larger than b² such that equation (9) always has both a negative and a positive solution, the latter being the unique [CO₂] required. Finally, substituting this value back into equation (2) enables [O₂] to be deduced in the presence of less than 2 vol % CO₂.

The various strategies for determining the oxygen and carbon dioxide concentrations from the experimental values of i₁ and i₂ are easily applied by microprocessor control. The present invention accordingly provides a computer program having code components that, when loaded on a computer and executed, will cause that computer to carry out step (d) of the method of the invention. The present invention also provides a computer readable storage medium having recorded thereon code components that, when loaded on a computer and executed, will cause that computer to carry out step (d) of the method of the invention.

The apparatus for determining the concentrations of oxygen and carbon dioxide of the present invention may be as described in WO 95/00838, except that the apparatus is additionally configured to carry out step (d) of the method of the present invention and there is no need to sweep the potential at a rate sufficient to minimise the interfering effect of reaction (II) above.

The fluid may be a gas or a liquid, e.g. a body fluid such as whole blood or serum. Suitable membrane materials include, for example, polytetrafluoroethylene (PTFE) or porous PTFE. The solvent is preferably non-aqueous. Examples of suitable solvents include DMSO, dimethylformamide (DMF), acetonitrile (MeCN) and propylene carbonate. A conductivity improver such as TEAP may also be present. The working microelectrode may, for example, be of silver or carbon or platinum or more preferably of gold. The counter electrode may, for example, be of platinum or gold. A reference electrode may be included in the system. The reference electrode may, for example, be a silver wire quasi-reference electrode or a thallium amalgam/TICI electrode.

According to the present invention, the working microelectrode is used to apply a first electric potential which is effective to reduce oxygen in the solvent and a second electric potential which is effective to reduce carbon dioxide in the solvent. The electric potential may, for example, be swept over a range effective to reduce the oxygen and carbon dioxide gases in the solvent, typically from −0.5 V to −2.5 V or greater (i.e. more negative). However, the sweep rate must be sufficiently slow not to change the steady-state character of the voltammetric signal. The rate of potential sweep may for example be up to 10 Vs⁻¹, preferably from 1 to 100 mVs⁻¹, typically about 50 mV s⁻¹. In practice, it may be preferable to pulse the electrode between voltages corresponding to the two voltammetric waves, wait until a steady state is achieved, and then measure the current, i.e. not sweeping but rather stepping of the applied electric potential. The values of the first and second electric potentials are those values which correspond to the transport limited currents for the reduction of oxygen and carbon dioxide respectively. The first electric potential may for example be from −0.5 to −1.1 V, preferably from −0.7 to −0.9 V, typically about −0.8 V. The second electric potential may for example be from −1.5 to −2.5 V, preferably from −1.7 to −2.1 V, typically about −1.9 V.

The size and shape of the working microelectrode must be such as to give microelectrode characteristics. The working microelectrode typically has the shape of a disc, but other shapes are possible, for example an array of discs, a band, a ring, or an ellipse. The working electrode preferably has a surface area of 2000 μm² or less, more preferably 500 μm² or less, most preferably 80 μm² or less. If the working microelectrode is a microdisc electrode, it preferably has a diameter of 50 μm or less, more preferably 25 μm or less, most preferably 10 μm or less.

The present inventors have found that the kinetics of the titration reaction between O_{2.}⁻ and CO₂ (reaction (II) above) depend on the choice of solvent. The difference in solvation of the superoxide radical anion in a non-aqueous solvent such as DMSO, DMF or MeCN may be sufficient to slow down the titration reaction, resulting in at least a partial decoupling of the oxygen and carbon dioxide reduction reactions (reactions (I) and (III) above). The kinetics of the attack have been studied by analysing steady-state voltammograms at an 8 μm gold microdisc electrode in DMSO, DMF and MeCN. The data fit well with an ECE or DISP1-type mechanism, with a slightly better fit of the data in the DISP1 pathway. In an ECE mechanism, the species generated by electron transfer undergoes a homogeneous chemical reaction to form a product that is also electroactive. The DISP1 mechanism is a variation of the ECE mechanism which arises if the product formed in the rate-determining chemical step undergoes homogeneous disproportionation, instead of a heterogeneous electron transfer process.

The following table indicates the DISP1 rate constant of the superoxide/carbon dioxide reaction, and gives estimates of the largest electrode diameters for which the reaction kinetics are outrun (resulting in substantially complete decoupling of reactions (I) and (III).

| | DMSO | DMF | MeCN |
|---|---|---|---|
| DISP1 k/M⁻¹s⁻¹ | 3.7 × 10⁵ | 1.1 × 10⁴ | 2.8 × 10² |
| Electrode Diameter/μm | 0.1 | 0.3 | 2.0 |
| Dielectric Constant | 4.7 | 36.7 | 37.5 |

Increasing the degree of decoupling of reactions (I) and (III) may facilitate the deconvolution of the signals i₁ and i₂ when the method of the invention is carried out. In view of the relatively low DISP₁ rate constant, particularly favourable results may be expected when the solvent is MeCN. The decrease in the kinetics is believed to be in part due to the greater stabilization of the transition state for the initial reaction in the case of MeCN compared with the other solvents.

The method and apparatus of the present invention enable the concentrations of both oxygen and carbon dioxide to be determined, using the same electrode and solvent. They are suitable not only for the determination of blood-gas concentrations but for a variety of other uses as well. Apparatus based on this approach may also be used for more general vapour analysis and as a volatile agent monitor. Applications include the medical field, for example in anaesthetic machines, and in the food industry.

1. A method of determining the concentration of oxygen gas, [O₂], and the concentration of carbon dioxide gas, [CO₂], in a fluid, which method comprises:
(a) applying the fluid to one side of a membrane permeable to the gases, the other side of the membrane retaining a solvent for the gases,
(b) using a working microelectrode in contact with the solvent to apply a first electric potential which is effective to reduce oxygen in the solvent and a second electric potential which is effective to reduce carbon dioxide in the solvent,
(c) measuring a first steady-state limiting electric current, i₁. corresponding to the reduction of O₂ to O_{2.}⁻ and a second steady-state limiting electric current, i₂, corresponding to both further reduction of O₂ and reduction of CO₂, and
(d) de-convoluting i₁ and i₂ to determine [O₂] and [CO₂].

2. A method according to claim 1, wherein step (d) comprises determining [O₂] and [CO₂] from a look-up table which provides a one-to-one correspondence between pairs of values of i₁ and i₂ and pairs of values of [O₂] and [CO₂].

3. A method according to claim 1, wherein step (d) comprises calculating [O₂] and [CO₂] in an iterative process.

4. A method according to claim 3, wherein the iterative process comprises calculating initial values of [O₂] and [CO₂] based on an assumed value of the effective number of electrons N_{eff} transferred during the oxygen reduction process, using these values of [O₂] and [CO₂] to calculate an improved value of N_{eff}, using the improved value of N_{eff} to calculate improved values of [O₂] and [CO₂], and repeating the calculation of improved values of N_{eff}, [O₂] and [CO₂] until successive values obtained for [O₂] and [CO₂] converge to within a desired tolerance.

5. A method according to claim 3, wherein the iterative process comprises:
(d1) assuming that the effective number of electrons N_{eff} transferred during the oxygen reduction process is equal to 2, and calculating a lower bound for [O₂] and an upper bound for [CO₂] using the equations
i₁=χN_{eff}[O₂] (1)
i₂=2χ[O₂]+κ[CO₂] (2)
in which χ and κ are empirically determined calibration constants,
(d2) identifying by reference to empirical data the effective number of electrons N_{eff} which would be transferred if the oxygen reduction process took place at an oxygen concentration [O₂] and a carbon dioxide concentration [CO₂] as calculated in step (d1),
(d3) using the value of N_{eff} obtained in step (d2) to calculate an improved value of [O₂] using equation (1),
(d4) using the value of [O₂] obtained in step (d3) to calculate an improved value of [CO₂] using equation (2), and
(d5) repeating steps (d2) to (d4), but using in step (d2) the values of [O₂] and [CO₂] last obtained in steps (d3) and (d4), until successive values obtained for [O₂] and [CO₂] converge to within a desired tolerance.

6. A method according to claim 1, wherein step (d) comprises calculating [O₂] and [CO₂] using the approximate equations
i₁=χ[O₂](1+[CO₂]/2.5) (7)
i₂=2i₁/(1+[CO₂]/2.5)+κ[CO₂] (8)
in which χ and κ are as defined in claim 5, and [O₂] and [CO₂] are expressed in units of mmol dm⁻³.

7. A method according to claim 1, wherein the solvent is dimethylsulfoxide, dimethylformamide, acetonitrile or propylene carbonate.

8. A method according to claim 1, wherein the working microelectrode is gold.

9. A method according to claim 1, wherein the working microelectrode has a surface area of 2000 μm² or less.

10. A method according to claim 1, wherein the working microelectrode is a microdisc electrode having a diameter of 50 μm or less.

11. A method according to claim 1, wherein the first electric potential is from −0.5 to −1.1 V and the second electric potential is from −1.5 to −2.5 V.

12. An apparatus for determining the concentrations of oxygen and carbon dioxide gases in a fluid, which comprises a membrane permeable to the gases, a solvent for the gases which is retained by the membrane, a working microelectrode and a counter and/or reference electrode in contact with the solvent, means for applying to the working microelectrode a first electric potential which is effective to reduce oxygen in the solvent and a second electric potential which is effective to reduce carbon dioxide in the solvent, and means for measuring a first steadystate limiting electric current, i₁, corresponding to the reduction of O₂ to O_{2.}⁻ and a second steady-state limiting electric current, i₂, corresponding to both further reduction of O₂ and reduction of CO₂, the apparatus being configured to carry out step (d) as defined in claim 1.

13. A computer readable storage medium having recorded thereon code components that, when loaded on a computer and executed, will cause that computer to carry out step (d) as defined in claim 1.

14. A computer program having code components that, when loaded on a computer and executed, will cause that computer to carry out step (d) as defined in claim 1.
